(19) United States
(12) Patent Application Publication
(10) Pub. No.: US 2014/0036372 A1
(43) Pub. Date: Feb. 6, 2014

(54) MOVABLE LIGHT-GUIDING DEVICE

(71) Applicant: CHI LIN TECHNOLOGY CO., LTD., Tainan City (TW)

(72) Inventors: Meng-Chung LEE, Tainan City (TW); Pin-Hsuan LIN, Tainan City (TW); Buh-Luen CHEN, Taipei City (TW); Pei-Chian TSAI, Tainan City (TW); Kai-Ping LIU, Taichung City (TW)

(21) Appl. No.: 13/945,563

(22) Filed: Jul. 18, 2013

(30) Foreign Application Priority Data
Jul. 31, 2012 (TW) 101214799

(51) Int. Cl. G02B 6/00; G02B 7/00

(52) U.S. Cl. CPC G02B 6/00; G02B 7/00
USPC 359/609; 359/601

(57) ABSTRACT

A movable light-guiding device includes a light-guiding unit and at least one sucker unit. The light-guiding unit includes at least one light-guiding structure. The sucker unit is installed on the light-guiding unit. Accordingly, a user can easily make the light-guiding device adhere to an object or remove it from an object by using the sucker unit. The movable light-guiding device can be repeatedly installed and uninstalled and thereby it can improve the performance and user's convenience.

### CROSS REFERENCE TO RELATED APPLICATIONS

This Non-provisional application claims priority under 35 U.S.C. §119(a) on Patent Application No(s). 101214799 filed in Taiwan, Republic of China on Jul. 31, 2012, the entire contents of which are hereby incorporated by reference.

### BACKGROUND OF THE INVENTION

1. Field of Invention

The present invention relates to a light-guiding device and, in particular, to a movable light-guiding device.

2. Related Art

As the progress of the optical technology in recent years, various kinds of light-guiding elements with different light-guiding functions have been invented and commercialized. These light-guiding elements can be applied to different applications, such as electronic products, construction and decoration, etc. However, the conventional light-guiding devices are usually installed at one location, so that they can not be easily uninstalled and installed repeatedly at different places. The performance of light-guiding devices is degraded greatly.

Therefore, it is an important subject to provide a movable light-guiding device that allows being repeatedly installed and uninstalled, thereby improving the performance thereof.

### SUMMARY OF THE INVENTION

An objective of the invention is to provide a movable light-guiding device that allows being repeatedly installed and uninstalled.

To achieve the above objective, the present invention discloses a moveable light-guiding device including a light-guiding unit and at least one sucker unit. The light-guiding unit includes at least one light-guiding structure, and the sucker unit is installed on the light-guiding unit.

In one embodiment, the light-guiding unit further includes a first transparent film and a second transparent plate, the first transparent film includes a first side and a second side opposites to the first side, the second transparent plate is disposed adjacent to the first side of the first transparent film, and the light-guiding structure is disposed on the second side of the first transparent film.

In one embodiment, the light-guiding unit further includes a third transparent plate disposed adjacent to the second side of the first transparent film.

In one embodiment, the light-guiding unit further includes a second transparent film disposed adjacent to the second side of the first transparent film.

In one embodiment, the light-guiding unit is configured for guiding the sunlight.

In one embodiment, the light-guiding unit includes at least one hole, and the sucker unit inserts the hole of the light-guiding unit.

In one embodiment, the light-guiding unit includes four holes disposed near four corners of the light-guiding unit, and there are four sucker units insert the holes of the light-guiding unit respectively. In one embodiment, the sucker unit comprises a base of the sucker unit, a sealed shaft, a spring, a pressing member and a limiting member. The base of the sucker unit includes a first hollow bushing, and the sealed shaft inserts the hollow bushing. The spring mounts on the sealed shaft. The pressing member locks the sealed shaft and contacts against the spring. The limiting member includes a second hollow bushing mounting on the pressing member, the spring and the sealed shaft, thereby locking the limiting member on the base of the sucker unit. The sealed shaft further includs a washer contacts against an inner margin of the base of the sucker unit.

In one embodiment, the movable light-guiding device adhered to a window.

As mentioned above, the movable light-guiding device of the invention includes a sucker unit disposed on a light-guiding unit. Accordingly, the user can easily remove the sucker unit from an object or make the sucker unit adhere to an object, so that the movable light-guiding device can be repeatedly installed and uninstalled, thereby improving the performance thereof.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a movable light-guiding device according to an embodiment of the invention;

FIGS. 2A to 2E are schematic diagrams showing various aspects of the light-guiding unit according to the embodiment of the invention;

FIG. 3A is a schematic diagram showing a sucker unit according to the embodiment of the invention; and

FIG. 3B is an exploded diagram of the sucker unit of FIG. 3A.

### DETAILED DESCRIPTION OF THE INVENTION

The present invention will be apparent from the following detailed description, which proceeds with reference to the accompanying drawings, wherein the same references relate to the same elements.

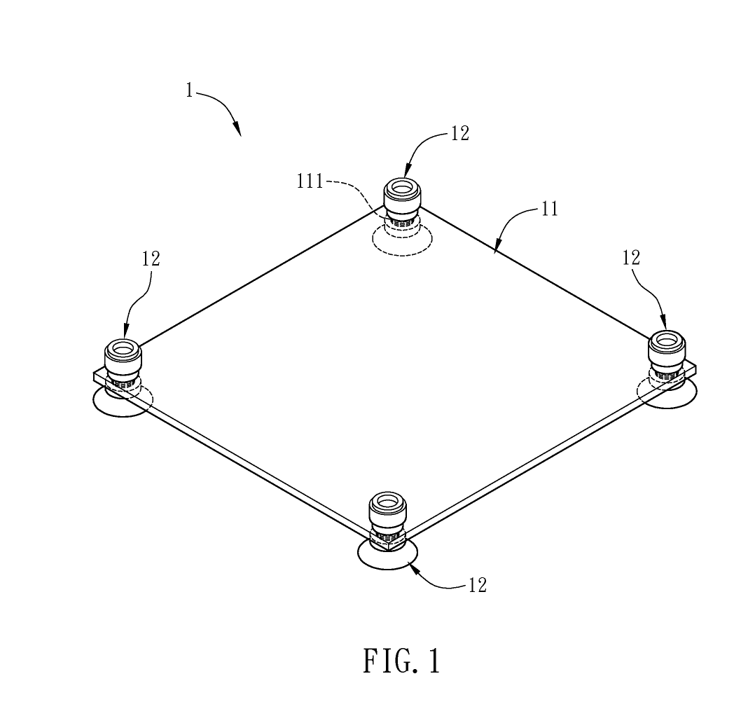

FIG. 1 is a schematic diagram showing a movable light-guiding device 1 according to an embodiment of the invention. The movable light-guiding device 1 includes a light-guiding unit 11 and at least one sucker unit 12 installed on the light-guiding unit 11. In this aspect, the movable light-guiding device 1 includes four sucker units 12. Besides, the light-guiding unit 11 includes four holes 111 disposed near four corners of the light-guiding unit 11, and the sucker units 12 insert the holes 111 of the light-guiding unit 11, respectively. The application fields of the movable light-guiding device 1 are not limited. For example, the sucker units 12 of the movable light-guiding device 1 can be adhered to a glass or other objects. The light-guiding unit 11 is configured to guide the sunlight, lamp lighting or other kinds of light. In this case, the light-guiding unit 11 is configured to guide the sunlight for example. In order to increase the applications, a surface of the light-guiding unit 11 may be configured with at least one pattern or at least one color, which is not limited in this embodiment.

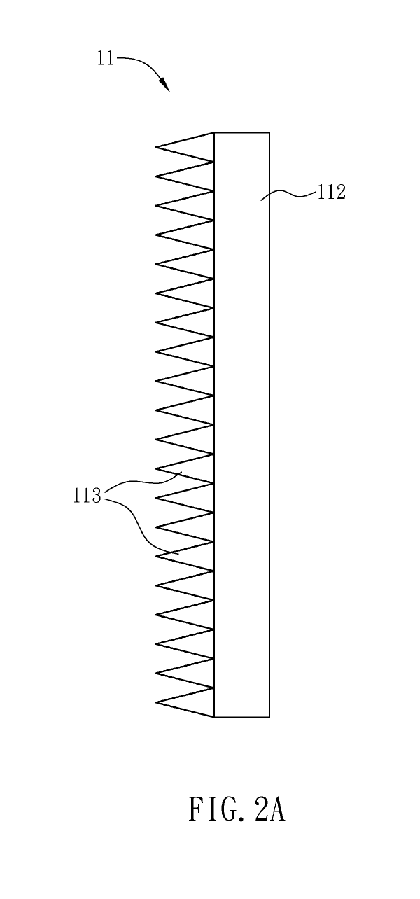

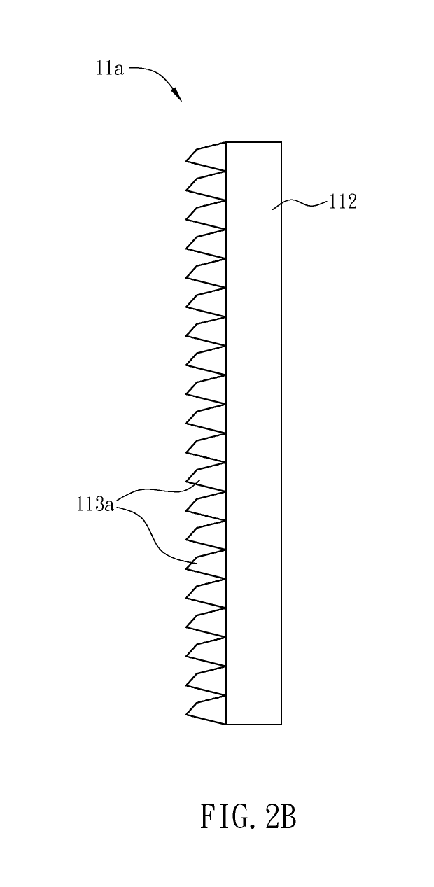

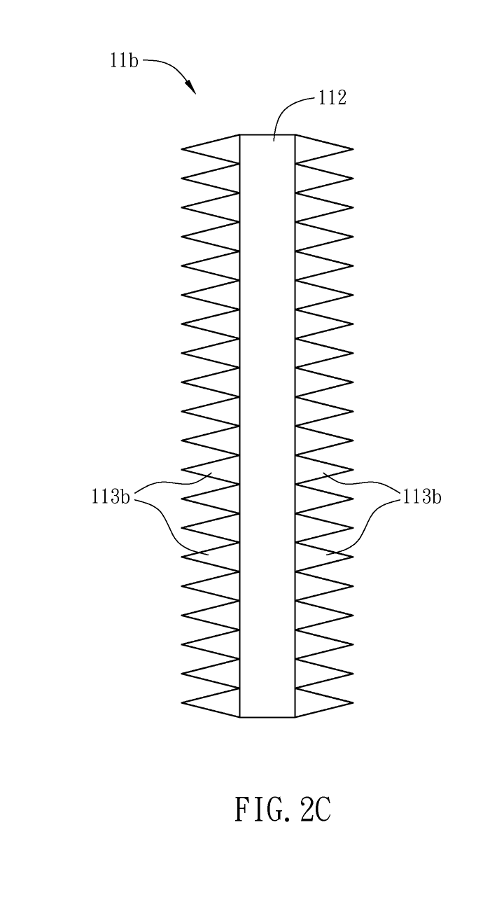

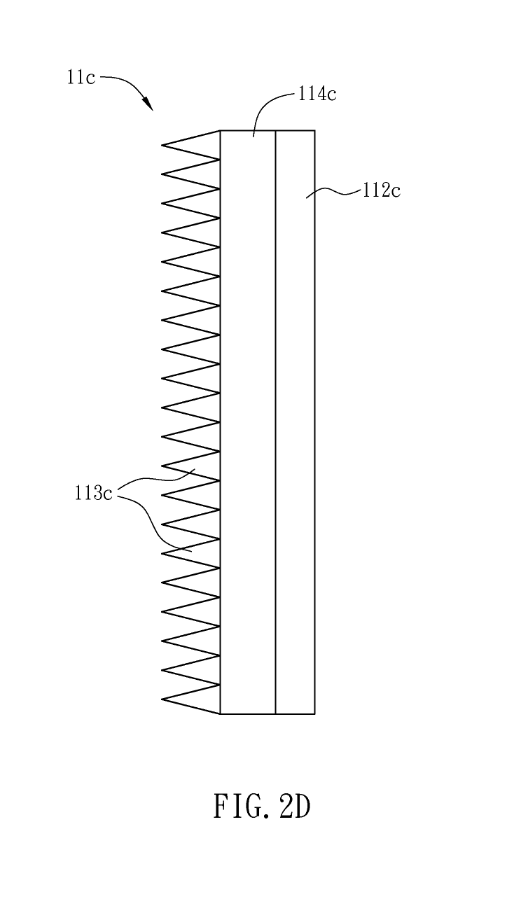

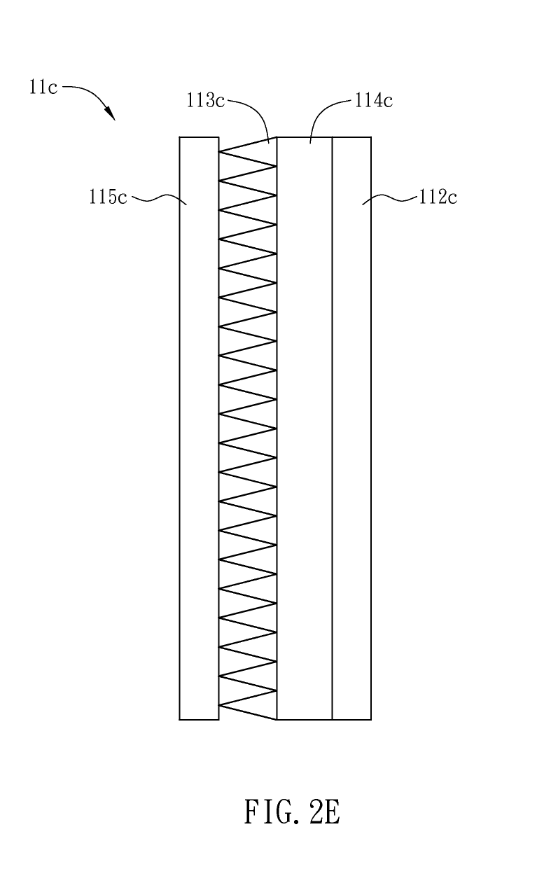

The aspects of the light-guiding unit 11 are substantially not limited in this embodiment. Some available examples will be described hereinafter with reference FIGS. 2A to 2E.

Referring to FIG. 2A, the light-guiding unit 11 includes a first transparent plate 112 with a plate shape, which is made of, for example, glass or other transparent materials. The light-guiding unit 11 includes a light-guiding structure 113 disposed at one side of the first light-guiding plate 112. In this aspect, the light-guiding structure 113 includes a saw-dented shape containing a plurality of triangular cross-section. Of course, the shape of the light-guiding structure can be modified according to requirements. For example, part of the light-guiding structure 113 can be modified into an arc or polygonal shape. Moreover, the angles of the triangular cross-section can be changed based on the light-guiding demand and are not limited. In this embodiment, the light-guiding structure 113 and the first transparent plate 112 are integrally molded.

Referring to FIG. 2B, a light-guiding structure 113a of the light-guiding unit 11a is a polygonal shape for example.

Referring to FIG. 2C, the light-guiding unit 11b includes a plurality of light-guiding structures 113b, which are disposed at opposite sides of the first transparent plate 112.

Referring to FIG. 2D, the light-guiding unit 11c includes a first transparent film 114c and a second transparent plate 112c. The first transparent film 114c includes a first side and a second side opposite to each other. The second transparent plate 112c is disposed adjacent to the first side of the first transparent film 114c, while the light-guiding structure 113c is disposed at the second side of the first transparent film 114c.

Referring to FIG. 2E, the light-guiding unit 11c further includes a third transparent plate 115c, which is disposed adjacent the second side of the first transparent film 114c. The light-guiding structure 113c is disposed between the first transparent film 114c and the third transparent plate 115c. In some aspects, the third transparent plate 115c can be replaced by a second transparent film (not shown) so that the light-guiding unit is thinner and lighter.

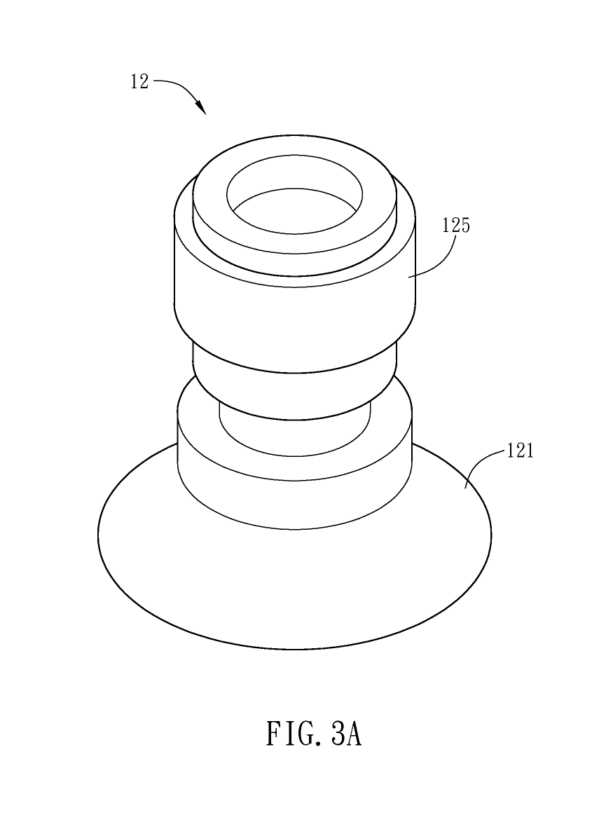

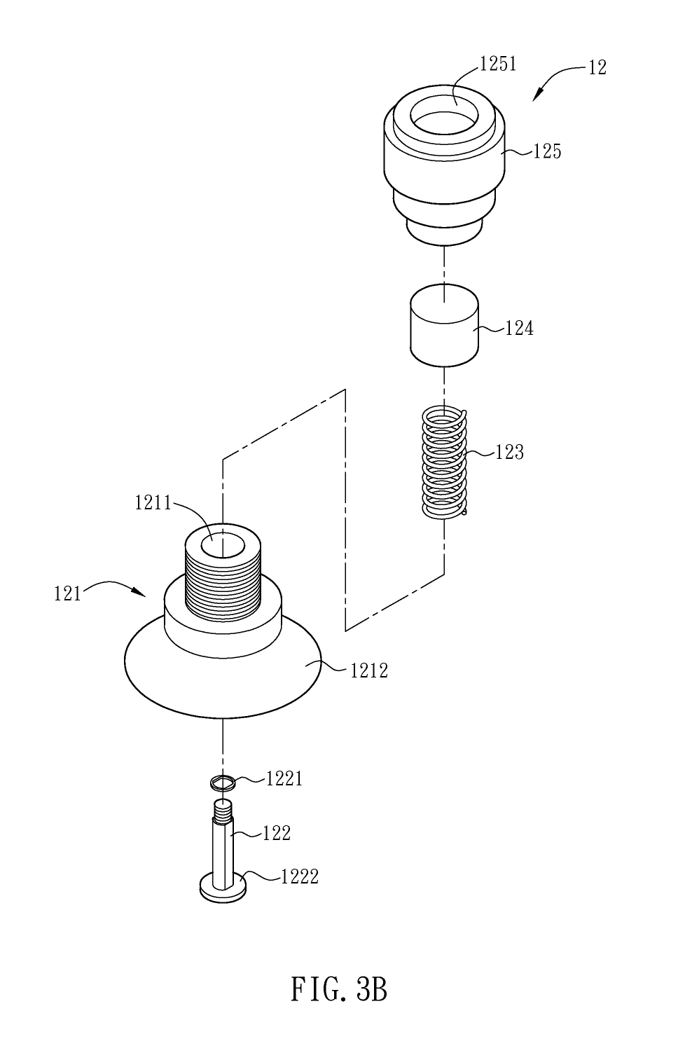

FIG. 3A is a schematic diagram showing a sucker unit 12 according to the embodiment of the invention, and FIG. 3B is an exploded diagram of the sucker unit 12. To be noted, the sucker unit 12 shown in FIGS. 3A and 3B is for illustrations, but not to limit the invention. Referring to FIGS. 3A and 3B, the sucker unit 12 includes a base of the sucker unit 121, a sealed shaft 122, a spring 123, a pressing member 124, and a limiting member 125. The base of the sucker unit 121 includes a first hollow bushing 1211 and a flexible element 1212, and the first hollow bushing 1211 connects with the flexible element 1212. The sealed shaft 122 inserts the hollow bushing 1211. The sealed shaft 122 further includes a washer 1221 disposed at an inner edge of the base of the sucker unit 121, in particular, at an inner edge of the flexible element 1212. The washer 1221 also contacts against a head portion 1222 of the sealed shaft 122. The spring 123 mounts on the sealed shaft 122. The pressing member 124 locks the sealed shaft 122 and contacts against the spring 123. The limiting member 125 includes a second hollow bushing 1251 mounting on the pressing member 124, the spring 123 and the sealed shaft 122, thereby locking the limiting member 125 on the base of the sucker unit 121. For example, the second hollow bushing 1251 is locked with the external thread of the first hollow bushing 1211 of the base of the sucker unit 121.

In practice, the sucker unit 12 is pushed toward a window so as to install the light-guiding unit 11 (see FIG. 1) on the window. In this circumstance, the washer 1221 against the inner edge of the base of the sucker unit 121 to form a low-pressure state (vacuum state) inside the flexible element 1212 of the base of the sucker unit 121, thereby providing the desired sucking effect. To remove the light-guiding unit 11 (see FIG. 1) from the window, the user need to uninstall the sucker unit 12 from the window. Firstly, the user holds the limiting member 125 and then presses the pressing member 124. Accordingly, the pressing member 124 is forced to move within the second hollow bushing 1251 of the limiting member 125 and compress the spring 123 and the sealed shaft 122. As the sealed shaft 122 is compressed downwardly, the head portion 1222 and washer 1221 of the sealed shaft 122 are slightly separated from the inner edge of the base of the sucker unit 121. Thus, the pressure inside the flexible element 1212 of the base of the sucker unit 121 increases, so that the suction effect of the sucker unit 12 is released. As a result, the sucker unit 12 can be easily uninstalled from the window.

In summary, the movable light-guiding device of the invention includes a sucker unit disposed on a light-guiding unit. Accordingly, the user can easily make the light-guiding device adhere to an object or remove it from an object by using the sucker unit. The movable light-guiding device can be repeatedly installed and uninstalled, and thereby it can improve the performance and user's convenience.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A movable light-guiding device, comprising:
a light-guiding unit having at least one light-guiding structure; and
at least one sucker unit installed on the light-guiding unit.

2. The movable light-guiding device according to claim 1, wherein the light-guiding unit further includes a first transparent film and a second transparent plate, the first transparent film includes a first side and a second side opposites to the first side, the second transparent plate is disposed adjacent to the first side of the first transparent film, and the light-guiding structure is disposed on the second side of the first transparent film.

3. The movable light-guiding device according to claim 2, wherein the light-guiding unit further includes a third transparent plate disposed adjacent to the second side of the first transparent film.

4. The movable light-guiding device according to claim 2, wherein the light-guiding unit further includes a second transparent film disposed adjacent to the second side of the first transparent film.

5. The movable light-guiding device according to claim 1, wherein the light-guiding unit is configured for guiding the sunlight.

6. The movable light-guiding device according to claim 1, wherein the light-guiding unit includes at least one hole and the sucker unit inserts the hole of the light-guiding unit.

7. The movable light-guiding device according to claim 1, wherein the light-guiding unit includes four holes disposed at four corners of the light-guiding unit, and the movable light-guiding device comprises four sucker units insert the holes of the light-guiding unit, respectively.

8. The movable light-guiding device according to claim 1, wherein the sucker unit comprises a base, a sealed shaft, a spring, a pressing member and a limiting member. The base of the sucker unit further includes a first hollow bushing, the sealed shaft inserts the hollow bushing, the spring mounts on the sealed shaft, the pressing member locks the sealed shaft and contacts against the spring, and the limiting member includes a second hollow bushing mounting on the pressing member, the spring and the sealed shaft, thereby locking the limiting member on the base of the sucker unit.

9. The movable light-guiding device according to claim 8, wherein the sealed shaft further includes a washer disposed at an inner edge of the base of the sucker unit.

10. The movable light-guiding device according to claim 1, wherein the movable light-guiding device is adhered to a window.
